(19) United States
(12) Patent Application Publication
(10) Pub. No.: US 2026/0122621 A1
(43) Pub. Date: Apr. 30, 2026

(54) FREQUENCY COORDINATION ORCHESTRATOR

(71) Applicant: HEWLETT PACKARD ENTERPRISE DEVELOPMENT LP, Spring, TX (US)

(72) Inventors: SUBBIAH NAGARAJAN VEERABUDRAN, Santa Clara, CA (US); Nethra MUNIYAPPA, Santa Clara, CA (US); Amit Praful GHETIYA, Spring, TX (US); Kuan-Ju CHEN, Spring, TX (US); Mayank GOYAL, Spring, TX (US)

(21) Appl. No.: 18/930,714

(22) Filed: Oct. 29, 2024

(51) Int. Cl. H04W 72/0453; H04W 88/08

(52) U.S. Cl. CPC H04W 72/0453; H04W 88/08

(57) ABSTRACT

Systems and methods are provided for automated frequency coordination (AFC), by ingesting, at a cloud-based frequency coordination orchestrator, from a mobility conductor (MCR), telemetry data from access points (APs) of a non-cloud managed deployment. The telemetry data can be validated, and a determination can be made as to whether one or more of the APs require AFC. If so, an AFC request for the requisite APs can be scheduled to be forwarded to an AFC server. In response, the AFC server can provide information regarding one or more allowed channels and operating power levels for the requisite APs. The cloud-based frequency coordination orchestrator can concurrently perform AFC operations with respect to APs in a cloud-based AP deployment, making the cloud-based frequency coordination orchestrator universally applicable to both types of AP deployments.

### BACKGROUND

Wireless technologies have become ubiquitous, and certain regulations exist that govern the use of the radio frequency (RF) spectrum. In the United States, for example, the Federal Communications Commission (FCC) promulgates rules that govern the use of the RF spectrum and wireless bands. Similar agencies or regulatory authorities exist around the world. Regardless, of location/agency, the typical regulatory construct for bands in the RF spectrum comprises licensed bands and unlicensed bands (and sometimes lightly licensed bands).

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration in which examples of the disclosed technology may be implemented.

FIG. 2 illustrates an example automated frequency coordination system in accordance with examples of the disclosed technology.

FIG. 3 illustrates ingestion and query services of a mobility controller application programming interface gateway in accordance with examples of the disclosed technology.

FIG. 4 is a detailed schematic representation of a scheduler microservice in accordance with examples of the disclosed technology.

FIG. 5 illustrates an example of a GPS ellipse used in determining a possible new AP location in accordance with examples of the disclosed technology.

FIG. 6 is an example workflow that can be implemented for bringing up a new AP in accordance with examples of the disclosed technology.

FIG. 7 illustrates a rebooting/restarting AP workflow in accordance with examples of the disclosed technology.

FIG. 8 illustrates an example computing component executing instructions for effectuating automated frequency coordination in accordance with examples of the disclosed technology,

FIG. 9 is a computing component that may be used to implement examples of the disclosed technology.

The figures are not exhaustive and do not limit the present disclosure to the precise form disclosed.

### DETAILED DESCRIPTION

On the 6 GHz band of the radio frequency (RF) spectrum, three types of unlicensed operations are permitted while protecting an incumbent's services. As used herein, the term “incumbent” can refer to a user that has been authorized to operate in a particular band, and is protected from harmful interference (from other users/wireless technologies, etc.). A first type of unlicensed operation is the indoor operation/use of Wi-Fi Access Points (APs) at a lower power. A second type of unlicensed operation can take the form of very low power, mobile indoor/outdoor APs used to effectuate Personal Area or In-Vehicle networks. A third type of unlicensed operation can occur in the 5.925-6.425 GHz and 6.525-6.875 GHz sub-bands, where APs are permitted to operate indoors and outdoors at standard power levels under the control of a system referred to as AFC (Automated Frequency Coordination). The operation of APs at standard power levels is controlled by AFC to prevent harmful interference to microwave links that operate in the 6 GHz band.

AFC refers to a system that coordinates use of the RF spectrum by way of a registered database (that has passed various checks/approvals by the govt. or appropriate regulatory body) of the bands in use by various types of RF services/devices in a given geographical areas. Various third party vendors (referred to herein as AFC vendors) may provide/host/maintain such a registered database. AFC is used by Wi-Fi APs, especially those operating in the 6 GHz band. It should be noted that while examples of the disclosed technology are presented in the context of 6 GHz Wi-Fi communications, the application of examples of the disclosed technology is not necessarily limited to the 6 GHz Wi-Fi environment.

The 6 GHz band/spectrum can support certain types of unlicensed operations so long as the unlicensed use does not collide or interfere with licensed users/services (incumbents) of the 6 GHz band. The aforementioned location information (along with AP state-related information) can be sent to an AFC vendor. The AFC vendor may then return the spectrum and power-level grant information for the APs in accordance with which the APs are allowed to operate. A critical aspect of the disclosed technology is that such systems and methods work with any type of AP deployment, whether the APs are “silo'ed,” or self-contained, where the APs do not interact with other entities outside of its own deployment/network, or whether the APs belong to a non-silo'ed deployment, e.g., AP deployments that can be managed by a cloud platform, for example.

An AFC system should make sure that APs operate on the allowed frequencies and power-levels. The AFC system should further conform and work seamlessly across different types of AP deployments, i.e., APs managed by cloud infrastructure (non-silo'ed) or managed by on-premise controllers (silo'ed). Thus, examples of the disclosed technology provide a mechanism for the intake of location and state information associated with an AP for purposes of obtaining spectrum and power-level grant information. For silo'ed deployments, a relay agent is implemented on a mobility conductor that forwards AP telemetry data from an AP to a cloud platform on which a frequency coordination orchestrator resides. The relay agent on the mobility conductor also pulls the AFC response/AFC channel data from the cloud platform and propagates the data to the AP. This can be accomplished using an API framework. APs undergoing a reset or reboot (or are new to the network) can be prioritized by the relay agent, and radio bring-up time after and AP restart can be significantly reduced using historical AFC spectrum and power level determinations, if the AP remains in the same location.

Incoming telemetry data is split into location/GPS information and AP state information by a first gateway. This is done because telemetry data from non-silo'ed deployments that directly communicate with the cloud platform are ingested separately. This makes information processing uniform across any type of deployment. A backend database is maintained for received information and AFC responses (for historical optimization purposes), and a query service maintains a pool of connections for querying the database.

A control flow pipeline includes a state processor, a scheduler, and an external gateway (that interfaces with the third party AFC vendor). The state processor validates incoming data (from the ingestion of AP telemetry), e.g., via sanity checks as will be described below, and filters out APs without valid information, and detects restarted/rebooted/new APs. The scheduler determines when an AFC request should be made for an AP identified by the state processor based on factors such as the AP's GPS position, time of day, expiry period of a previous AFC grant and country code. The scheduler may calculate an AFC request schedule based on AP deployment time zone, when a current AFC response expires, and an approximate time of when channel and power assignment algorithms will start. The third party AFC vendor system tracks spectrum use by geographical location, and responds to an AFC request with allowed channel(s) and power values for a geographical location. The external gateway intercepts this response, and stores the information in the database for retrieval. In some examples, the external gateway can aggregate AFC requests for resource savings/efficiency.

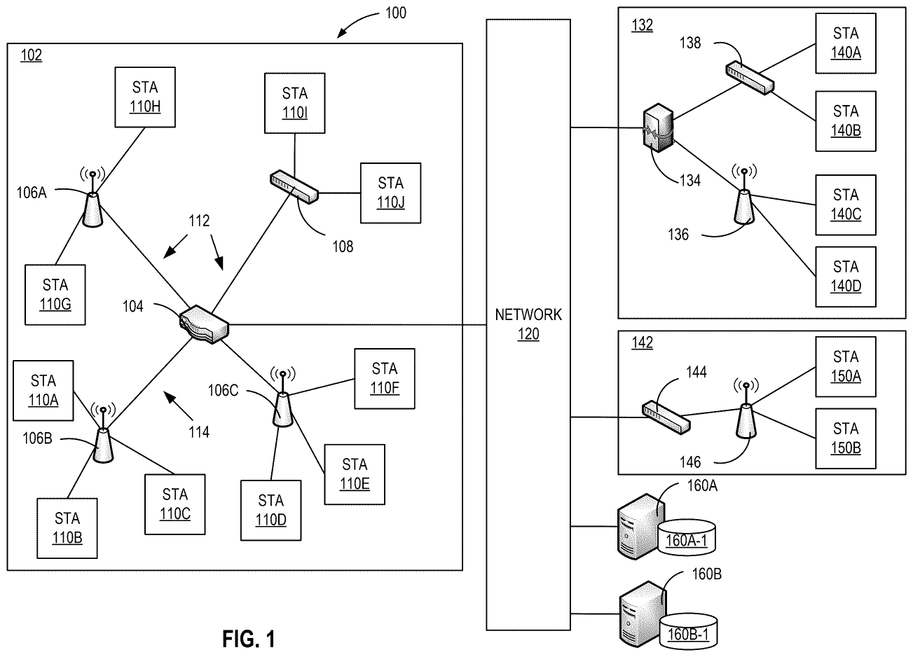

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices or stations (STAs) 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, the primary site 102 includes a controller 104, which is in communication with the network 120. The controller 104 may provide communication with the network 120 for the primary site 102. There may be other points of communication with the network 120 for the primary site 102 in addition to controller 104. Although single controller 104 is illustrated, the primary site 102 may include multiple controllers and/or multiple communication points with network 120. In some embodiments, the controller 104 may communicate with the network 120 through a router. In other embodiments, the controller 104 provides router functionality to the devices in the primary site 102. In this specification, the word “tunnel” refers to an encapsulated mode of transporting data between AP and controller. In this example, primary site 102 may be considered a silo'ed deployment with APs being controlled by a local/co-located controller 104.

The controller 104 may be operable to configure and manage network devices, such as at the primary site 102, and may also manage network devices at the remote sites 132, 142, e.g., act as a cloud-based controller. The controller 104 may be operable to configure and/or manage switches, routers, access points, and/or client devices connected to a network. The controller 104 may itself be, or provide the functionality of, an Access Point (AP).

The controller 104 may be in communication with one or more switches 108 and/or wireless APs 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of client devices/STAs may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired or wireless connection 112. In the illustrated example, the switch 108 communicates with the controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1 may be a satellite office, another floor or suite in a building, for example. The remote site 132 may include a gateway device 134 for communicating with the network 120. A gateway device 134 may be a router, a digital-to-analog modem, a cable modem, a digital subscriber line (DSL) modem, or some other network device configured to communicate with the network 120. The remote site 132 may also include a switch 138 and/or AP 136 in communication with the gateway device 134 over either wired or wireless connections. The switch 138 and AP 136 provide connectivity to the network for various client devices 140a-d. In such a deployment, remote site 132 may be considered to be a cloud-controlled or non-silo'ed deployment.

In some embodiments, the remote site 132 may be in direct communication with primary site 102, such that client devices 140a-d at the remote site 132 access the network resources at the primary site 102 as if these client devices 140a-d were located at the primary site 102. In such embodiments, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various embodiments, the network configuration 100 may include one or more smaller remote sites 142, comprising only a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the primary site 102, such that the client devices 150a-b at the remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102. Remote site 142 may also be considered to be a non-silo'ed deployment

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. The client devices 110a-j, 140a-d, 150a-b may request and access the multimedia content provided by the content servers 160a-b.

In another example, servers 106a-b may comprise cloud-based network management servers making up a cloud-based network management system for managing, e.g., sites/deployments 102, 130, and 142 in accordance with the examples disclosed herein. Being cloud-based would be understood by those of ordinary skill in the art to refer to being, e.g., remotely hosted on a system/servers in a network (rather than being hosted on local servers/computers) and remotely accessible. Servers 160a, 160b may have or may be associated with one or more databases, e.g., database 160a-1 and 160b-1, respectively for storing data or information, e.g., telemetry data comprising AP state/location information.

As will be described in greater detail below, a centralized, e.g., cloud-based network management system or platform may comprise a frequency coordination orchestrator (FCO). Such a frequency coordination orchestrator may act as a proxy for AP deployments to enable APs/AP deployments to operate in accordance with AFC to avoid interfering with incumbents or their services while still being able to operate (support STAs' communications) at appropriate power levels and on allowed frequency bands.

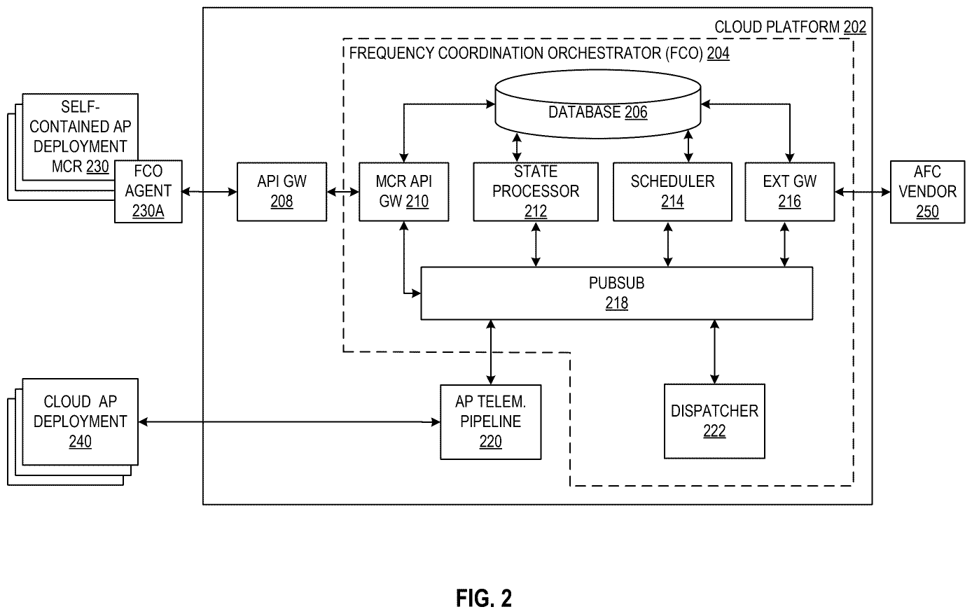

FIG. 2 illustrates an example AFC system comprising a frequency coordination orchestrator 204, which may be implemented on a cloud platform 202, such as a centralized, cloud-based network management system/platform. As noted above, frequency coordination orchestrator 204 may act as a proxy service for standard power AP deployments to exercise the AFC workflow. Again, the AFC workflow allows for APs to operate in accordance with permitted power levels and frequencies while avoiding collisions or interfering with incumbents. Permitted power level/frequency information can be provided by a third party AFC vendor that comports with the Federal Communications Commission's (FCC's) Universal Licensing System (ULS), according to which AFC systems operate.

As also noted above, conventional AFC systems are not capable of managing silo'ed or self-contained AP deployments. However, examples of the disclosed technology are capable of handling both self-contained AP deployments, as well as cloud-based or cloud-managed AP deployments. To that end, frequency coordination orchestrator 204 may receive telemetry data from two types of deployments, self-contained AP deployments and cloud AP deployments. Telemetry data or information may include, but is not limited to, a measure or estimate of quality of experience (QoE) on a traffic flow basis; flow characteristics and other quality of service (QoS) measurements, such as but not limited to, jitter, delay, airtime, latency, etc.; analytics; transmission protocols (e.g., OFDMA and MU-MIMO), and the like, referred generally as AP state information or data. APs may also have location information, e.g., GPS data, associated with their respective location(s).

In the case of self-contained AP deployments, an FCO agent, such as FCO agent 230A implemented on a mobility conductor (MCR), such as MCR 230, may forward telemetry data from one or more APs of a self-contained AP deployment to frequency coordination orchestrator 204. MCR 230 may comprise a customer site (deployment-side) device that can be used to manage “managed devices” (MDs) which in turn, can manage APs. For example, and referring back to FIG. 1, MCR 230 may be used to provide centralized control or management of multiple network controllers, one example of which is controller 104.

Because self-contained deployments have no “direct” link to or way to connect to the cloud, a Representational State Transfer Application Programming Interface (REST API)-based approach can be used. That is, MCR(s) 230 can transmit an AP's state/location information via POST REST API calls to an API gateway (GW) 208. API GW 208 may be a part of cloud platform 202 for supporting REST and Streaming APIs by providing an API interface to cloud platform 202. The POST API calls may be intercepted by an MCR API GW 210, which hosts a microservice that can normalize or transform the “raw” telemetry data into data or information that can be understood and consumed by frequency coordinator 204. That is, the format of an API payload can be transformed into a format that can be understood by cloud-specific services, e.g., via load, parse, validation, and conversion operations.

In particular, FCO agent 230A may parse telemetry data (AP state information and location information) relayed from MD(s) managed by MCR 230. FCO agent 230A can place the AP state/location information of an AP(s) as a JSON payload in the POST REST API call, which frequency coordination orchestrator 204 can expose for use. It should be noted in that in the interests of efficiency and resource savings, FCO agent 230A can batch/aggregate state and location information for a group of APs in a single REST API call.

FCO agent 230A can prioritize information regarding new and rebooting/resetting APs by forwarding AP state/location information associated with these APs as soon as FCO agent 230A detects such a new or a rebooting/resetting AP. That is, APs that are new to a network or have been rebooted may require information regarding what power levels those APs may operate at, and over what channel(s) those APs may operate on. In some examples, FCO agent 230A may forwards information of only those APs that require AFC processing. That is, processing/communications resources need not be burdened unless an AP is seeking to operate in a particular frequency band (e.g., in the 5.925-6.425 GHz and 6.525-6.875 GHz sub-bands), at a particular power, e.g., standard power, that is governed by AFC.

It should be noted that specialized handling of rebooted APs may be performed—hence the prioritization discussed above. Based on the telemetry data, frequency coordination orchestrator 204 may use a currently-reported location of an AP, and a previously-reported location of that AP to determine if a new AFC request may be warranted. As will be discussed in greater detail below, the decision to either re-use an existing AFC response or generate a new AFC request and wait for a new AFC response can be based on ellipse inequality principles. AFC responses are typically valid for 24 hours for a specific ellipse. This optimization can be realized based on the knowledge that most APs that experience a reboot are typically not changing their location, as it is generally rare for an AP to be relocated (although it can occur, e.g., as may be the case in a mobile environment, e.g., an AP deployment in a mobile environment, e.g., on a ship).

After the AP state/location information is forwarded, FCO agent 230A waits for a certain amount of time before retrieving (pulling) the AFC response from cloud platform 202 via REST API calls. FCO agent 230A can inspect the received AFC response(s) for the AP(s) required to follow AFC, and forwards the AFC response(s) to the respective AP(s) only if the AFC response is valid. If FCO agent 230A does not receive a proper response, it continues to forward AP state and location information as and when it receives such information. It should be noted that APs continue to send their location (e.g., GPS) information until an AP receives a valid AFC response. A valid response can be one that has the channel (e.g., a list of channel sets or a subset of the list of channel sets) and power level values that were requested for the AP.

It should be noted that once the APs have received their respective AFC responses, the frequency of location information being sent from the APs is drastically reduced. It should also be noted that FCO agent 230A forwards the AFC response for such APs periodically, e.g., only every few hours, to reduce the number of API calls made to cloud platform 202. This periodic update of information ensures that cloud platform 202 has the most up-to-date information about the APs and their location.

In the case of cloud-based deployments, such as cloud AP deployment(s) 240, telemetry data can be sent via a websocket (not shown). The telemetry data can then be consumed by (existing) AP telemetry pipeline 220. AP telemetry pipeline 220 exists as part of cloud platform 202 (apart from frequency coordinator orchestrator 204). That is, cloud platform 202 may utilize AP telemetry data for other purposes, besides comporting with AFC, e.g., to prioritize traffic flow(s) packet data transmission from an AP, load balancing traffic across APs, etc. AP telemetry pipeline 220 can then publish AP-related information on publish-and-subscribe (pubsub) messaging infrastructure 218. It should be noted that the pubsub functionality enables micro services (such as that for normalizing the raw telemetry data noted above) to communicate using messages for event-driven architectures.

An MCR API GW 210 ingests the telemetry data comprising AP state and location information that has been received as a JSON payload, and splits the payload into two messages. MCR API GW 210 may further transform the two messages and ensures routing of the two messages to pubsub infrastructure 218. MCR API GW 210 may also respond to query calls from MCR(s) 230 for the aforementioned AFC responses. Additionally still, MCR API GW 210 may maintain a pool of connections to query a backend database, e.g., database 206, sanitizes data, and returns the results of the query. The backend database 206 (which can be an embodiment of one of, e.g., databases 160a-1/160b-1 of FIG. 1) can comprise some local store in which the AP telemetry data can be stored/cached. As discussed above, historical optimization can be effectuated by eschewing generating a new AFC request/waiting for a new AFC response in favor of utilizing an existing AFC response according to which AP operation can be based. This backend database 206 can be maintained for received AF state/location information and AFC responses.

The AP's state and location information can be sent via pubsub infrastructure 218 to state processor 212. State processor 212 can validate incoming AP state/location information, and filter or weed out APs without valid information. Validity here can be determined by checking for, e.g., missing fields in the incoming AP state and location data, as well as ensuring that these parameters are within the allowed range. If valid, an AP's state/location information can be stored in backend database 206 noted above. State processor 212 can further detect AP reboot/restart conditions, or whether the AP state and location information is that associated with an AP that is new to the network.

A scheduler 214 can refer to another microservice of frequency coordination orchestrator 204. Scheduler 214 can be used to determine when an AFC request should be made on behalf of an AP. For example, if a determination is made (as noted above) that an APs information is valid, and for example, that the AP is no longer subject to a valid AFC response, such as when a valid AFC response has expired, scheduler 214 may determine that a new AFC request is warranted. Scheduler 214 can validate an AP's location information, for example, as well as a variety of other factors (discussed in greater detail below) as part of making its determination regarding whether or not a new AFC request is warranted.

An external GW 216 can make an AFC request, e.g., in response to scheduler 214 determining that a new AFC request for a particular AP is warranted. External GW 216 may further interface with an AFC vendor, e.g., AFC vendor 250, by making a REST API call to AFC vendor 250 to retrieve an AFC channel and power list for that AP, and in that AP's location. As discussed above, AFC vendor 250 can be a regulated/approved database/service that can be accessed to determine on what channel(s) and at what power level(s) an AP can operate pursuant to an AFC determination.

Upon receiving a successful AFC response from AFC vendor 250, external GW 216 can store the AFC response in database 206. External GW 216 may further notify scheduler 214 of this successful AFC response. As discussed above, scheduler 214 determines when an AFC request should be made on behalf of an AP. Accordingly, receipt of information that a successful AFC response was received can be a consideration/a factor to consider when making its determination. For example, if an AFC response is valid for, e.g., a 24-hour period, upon receipt of an AFC response for a particular AP, scheduler 214 will publish an instruction/notification to generate an AFC request to pubsub infrastructure 218 before the 24-hour period expires. In the case of APs that make up a self-contained deployment, MCR 230 can poll frequency coordination orchestrator 204 via REST API calls to obtain the AFC response. For cloud-managed APs, a dispatcher 222 can be used to handle the forwarding of an AFC response to an AP. That is, for cloud-managed APs, e.g., those in cloud AP deployment 240, a dispatch request can be sent via pubsub infrastructure 218 requesting that an AFC response be forwarded to the AP. Dispatcher 222 handles this dispatch request to effectuate the forwarding of the AFC response.

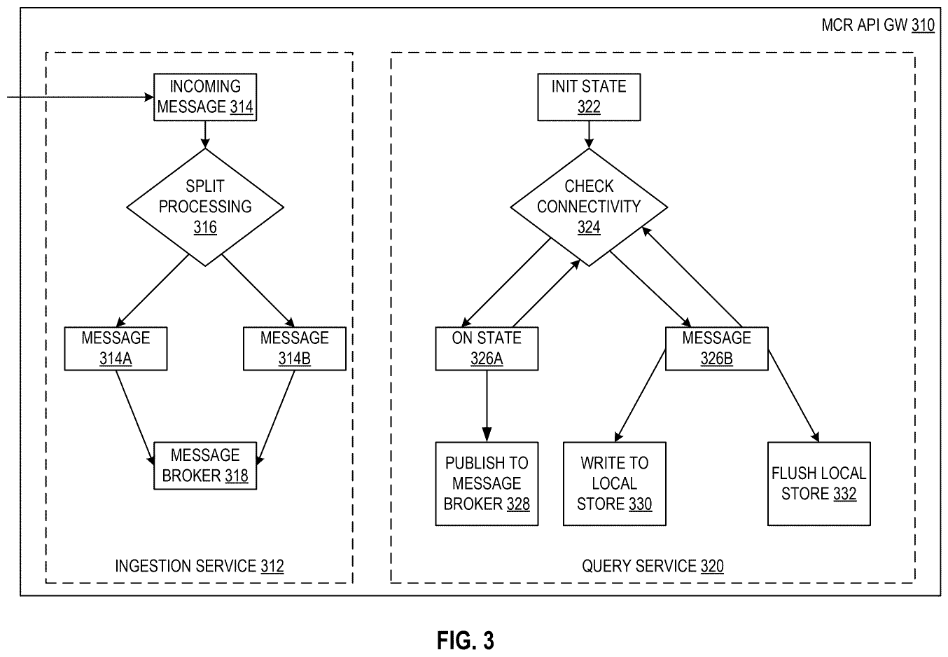

FIG. 3 illustrates two aspects of an MCR API GW 310 (which may be an embodiment of MCR API GW 210 of FIG. 2), in particular, an ingestion service 312, and a query service 320. As noted above, MCR API GW 310 may ingest telemetry data comprising AP state and location information that has been received as a JSON payload. It should be understood that this telemetry data being ingested by MCR API GW 310 is from APs in a self-contained deployment. Thus, ingestion service 312 may include an API handler that validates the incoming JSON payload, e.g., incoming message 314, representative of an AP's state and location information. Ingestion service 312 may split the JSON payload into two messages, i.e., effectuating split processing 316 of the message/JSON payload. Ingestion service 312 can split incoming message 314 into two messages 314A and 314B.

As previously explained, telemetry data is split into location information and AP state information. This is done because telemetry data from non-silo'ed deployments that directly communicate with the cloud platform are ingested separately. This makes information processing uniform across any type of deployment. When performing split processing 316, it should be noted that MCR API GW 310 also transforms the telemetry data into a format that can be ingested by a frequency coordination orchestrator, such as frequency coordination orchestrator 204 of FIG. 2.

Upon partitioning message 314 into messages 314A and 314B, MCR API GW 310 operates to save the partitioned messages 314A and 314B to the same shard on message broker 318. That is, database sharding can refer to the storage of a database (a large database) across multiple machines. Typically, database sharding involves the splitting of data in the database into smaller chunks, i.e., shards, that can be stored across a plurality of database servers. The use of message queuing (e.g., MQ Series or MSMQ) can be used for integrating enterprise applications, especially when those applications are running on different platforms. Here, the use of message queuing lends itself to the ingestion of AP telemetry data from two types of AP deployments, silo'ed/self-contained and non-silo'ed. Accordingly, a message broker, such as message broker 318 may be used to provide a mechanism(s) for the aforementioned translation or transformation of telemetry data to a form or format that is understandable by a frequency coordination orchestrator. Message broker 318 is an embodiment of the pubsub functionality/mechanism, and may also add supervision (detecting when a queued message is not picked up/received), routing (up to and including pubsub), and orchestration (for coordinating messages between systems) functionality to MCR API GW 310.

It should be noted that in some examples, MCR API GW 310 may store messages 314A/B locally, e.g., at database 206, if the above-described ingestion pipeline is not active. This could occur, e.g., if a connection to message broker 318 is lost/disconnected for a short period of time.

Query service 320, on the other hand, may involve maintaining a pool of connections to query the backend database (e.g., database 206 of FIG. 2), to sanitize data, and return results on the query. As illustrated in FIG. 3, based on an initial connection state 322, MCR API GW 310 checks the connectivity at 324. If the channel is alive, an ON state message 326A can be published at 328 to message broker 318. Periodic/continuous connectivity checks 324 can be made. If, however, a channel is down, and communications can't progress on that channel, and OFF state message 326B can be written to a local store at 330. If and when connectivity is restored after performing another connectivity check at 324, the local store at 332 can be flushed of the OFF state message 326B.

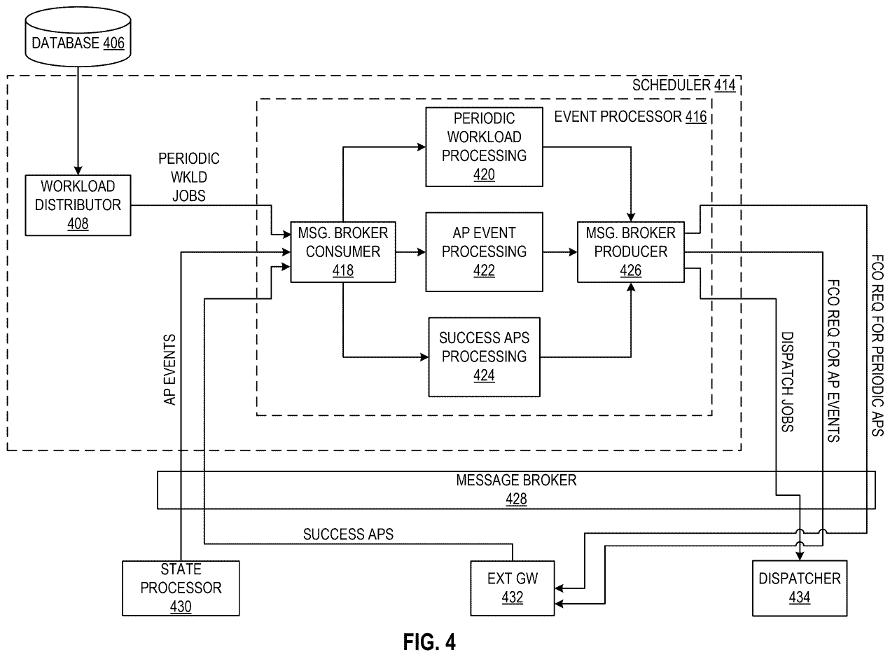

FIG. 4 is a detailed schematic representation of a scheduler component or microservice 414. Scheduler 414 may be an embodiment of scheduler 214 of FIG. 2. Database 406 may be an embodiment of backend database 206. State processor 430 may be an embodiment of state processor 212. External GW 432 may be an embodiment of external GW 216. Dispatcher 434 may be an embodiment of dispatcher 222.

A workload distributor 408 is operatively connected to database 406, and is responsible for periodically performing database query runs to fetch those APs (for whom AP state and location information was received, validated, and stored (as described above)), and that need an AFC request sent on their behalf. This query ensures that only active APs are processed. It should be understood that fetching APs can refer to determining or identifying via the query, from AP state and location information of a plurality of APs stored in database 406, those APs for whom a new AFC request is warranted. In some examples, a batch of APs may be received pursuant to the query. The information identifying this batch of APs may be sent as a protobuf message via pubsub infrastructure 218 to event processor 416.

As noted above, scheduler 414 may be used to determine whether or not to make an AFC request for a particular AP. While workload distributor 408 operates to fetch APs for which an AFC request is warranted, event processor 416 operates to make the determination as to whether or not an AFC request is warranted for a particular AP, as well as when that AFC request should be made (in accordance with a determined periodicity, e.g., every 24 hours as discussed above).

To that end, AP events messages can be raised by state processor 430 (which may be an embodiment of state processor 212 of FIG. 2) for those events that are related to an AP, e.g., a new AP coming up/seeking registration, an AP undergoing a restart or reboot, or an AP with a non-operational 6 GHz radio. For each AP event that arises from state processor 430, AP state information is obtained from database 406, and sanity checks may be performed. Sanity checks can involve source checking, e.g., checking the source of AP height and GPS information to see if those sources are allowed. If a sanity check fails regarding a particular AP, that AP can be ignored (for purposes of sending an AFC request).

Further to the above, and depending on the type of event that is raised by state processor 430, different operations may commence.

For a new AP event (an event raised by state processor 430 when an AP is coming up/registering the first time on a network), event processor 416 will create an FCO request job for AP events that ultimately can be sent to external GW 432, which can generate and transmit an AFC request to an AFC vendor, e.g., AFC vendor 250. When state processor 430 raises an AFC event, an AFC event message can be sent to message broker consumer 418 (used for reading event messages, as it subscribes to pubsub messages). AP event processing 422, as described in greater detail below, can refer to the handling of new AP, reboot, or AFC response reliability events. Message broker producer 426 may then write a message to external GW 432 so that external GW 432 can generate the AFC request. It should be noted that Kafka is one example of a message broker that can be used for the processing of event messages in scheduler 414, but examples of the disclosed technology are not necessarily limited to using the Kafka event platform.

In the case of a rebooting AP event (which can be raised by state processor 430 when an AP reboots), the AP may be collecting new/current location (e.g., GPS) data at increasing sampling intervals, which can be sent to frequency coordination orchestrator 204 as telemetry data. State processor 430 can create events for these sampling intervals so that they may be implemented, and can send old and new location information to event processor 416. For each interval message, event processor 416 may perform mathematical ellipse calculations (discussed in greater detail below) on this old/new location information to determine whether or not the location of the AP at issue has changed since or upon rebooting. It should be understood that this change location determination may be premised on the change being “significant,” significance being determined by a threshold, in this case, whether or not new location information is within/on a previous or old ellipse. If the AP's location has not changed significantly, and if a valid AFC response is already present, that AFC response can be sent to the AP via dispatcher 434 for APs belonging to a cloud-based deployment. For an AP of a self-contained deployment, an MCR API GW, e.g., MCR API GW 210 of FIG. 2, can be used to transmit the AFC response to the AP. Otherwise, a new FCO request job can be created for that AP when a sufficient number of location information (e.g., GPS) samples have been obtained from the AP to make a location change decision.

State processor 430 may raise yet another AP event, in particular, an AFC response reliability event. State processor 430 can raise an AFC response reliability event when the AP has come up successfully, but still does not have a valid AFC channel on which it may operate. If a valid AFC response is present in database 406, that AFC response can be sent to the AP via dispatcher 434 for cloud-based deployment APs.

As discussed above, AFC responses can expire, e.g., every 24 hours. Accordingly, scheduler 414 implements a periodic jobs workflow to refresh an existing AFC response before the 24-hour period expires. To accomplish this task, periodic workload processing 420 may involve workload distributor 408 periodically querying database 406 to determine if any APs are close to their respective 24-hour expiry period. If so, scheduler 414 can schedule such APs for an AFC request that can be sent by external GW 432.

More particularly, periodic workload processing component 420 may execute an algorithm that calculates a next schedule timestamp. Periodic workload processing 420 may involve using the following AP fields from database 406: timezone of the place where the AP is deployed; time when the current AFC response expires; and an approximate time when algorithms handling channel and power assignment will begin. Typically, frequency coordination orchestrator 204 (FIG. 2) runs on a daily basis. However, the possibility of disruptions on a customer's network at random times exists. To avoid such disruptions, examples of the disclosed technology uses a window of time between 12 AM-5 AM (in the AP's time zone) during which scheduler 414 can schedule periodic (every 24 hours in this example) AFC requests for the AP.

It should be noted that some countries do not allow for any grace periods regarding AFC responses, and as such, AFC responses in these countries expire exactly/strictly after 24 hours. In such scenarios, scheduler 414 can cause periodic AFC requests to be made at least one hour before the 24-hour expiration time. This can lead to a change in the time at which the periodic request is made, although the 12 AM-5 AM window is still maintained by making an AFC request twice in a day, approximately once every week. That is, scheduler 414 can use a sliding window mechanism wherein for every successive day, an AFC request can be scheduled to be sent/made one hour before expiry, between 12 AM-5 AM. If the AFC request is scheduled between 12 AM-1 AM, another AFC request can be scheduled between 4 AM-5 AM to reset the sliding window, and ensure continuous operation of the AP.

As also illustrated in FIG. 4, external GW 432 may raise messages when a valid AFC response has been received in response to an AFC request made on behalf on an AP to and AFC vendor, e.g., AFC vendor 250 of FIG. 2. For APs belonging to a self-contained AP deployment, success APs processing 424 can involve the MCR API GW, e.g., MCR API GW 210, fetch those APs corresponding entries from database 406 by directly querying the success APs corresponding entries. For cloud-managed deployments, success APs processing component 424 can request dispatcher 434 to forward the AFC response to the AP. For APs of a self-contained deployment, MCR API GW 210 can poll this information via REST API calls (as described above). Success APs processing component 424 may also update the AP's entry in database 406 to indicate that the AP has a valid AFC response. Timestamps related to the next schedule and dispatch jobs can also be updated in database 406.

That is, and as noted above, external GW 432 can interact with a third party that services AFC requests, e.g., AFC vendor 250 of FIG. 2. The third party or FCC ULS keeps track of spectrum usage in geographic locations across a country. When an AP's location is reported to the third party, the third party can respond with a list of channel and power values that are allowed for use at that specific location. External GW 432 intercepts this AFC response and stores the AFC response in database 406. Moreover, in some examples, external GW 432 can aggregate AFC requests for multiple APs at a time to save on network round trip cost and efficiency. Once external GW 432 receives a successful AFC response, external GW 432 notifies scheduler 414 via pubsub infrastructure 218 of FIG. 2. In some examples, external GW 432 may also manage an authentication mechanism for communicating with the third party, and may be responsible for the generation, renewal and management of API tokens used for communicating with the third party. Message broker 428 is an embodiment of the pubsub messaging functionality/mechanism

As discussed above, scheduler 214/414 may operate to determine whether or not an AFC request should be sent on behalf of an AP that has experienced a reboot. In particular, AP event processing component 422 may perform mathematical ellipse calculations on old/new location information to determine if an AFC request is warranted, i.e., to determine if new location, e.g., GPS, coordinates (latitude and longitude) that are reported by an AP lie within the ellipse that represents old location/GPS coordinates. The following fields can be reported by an AP, and can be used by AP event processing component 422 (running an algorithm described below) to make the determination: new_gps_info.latitude; new_gps_info.longitude; old_gps_info.latitude; new_gps_info.longitude; old_gps_info.major_axis; old_gps_info.minor_axis; and old_gps_info.orientation.

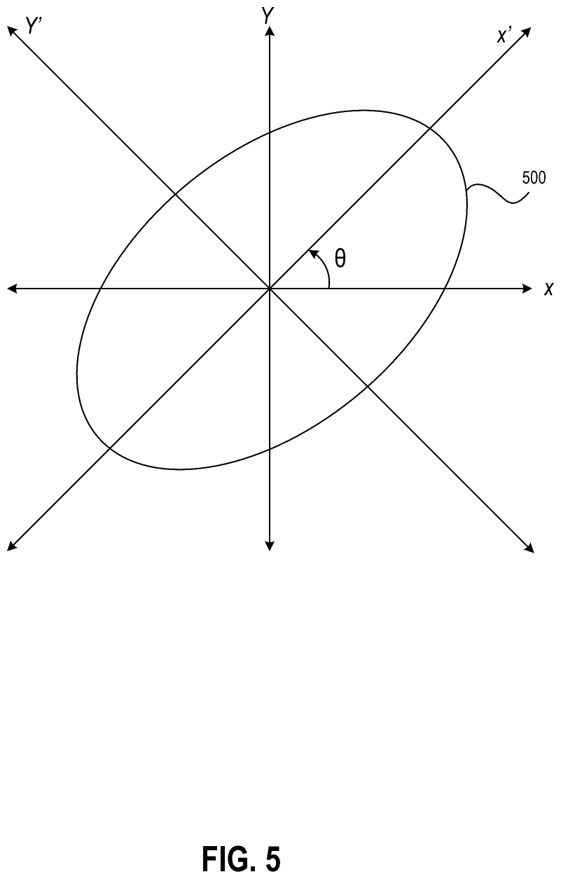

An assumption can be made that because the location/GPS ellipse radius that is obtained from an AP is very small relative to the radius of the earth, the location/GPS ellipse can be considered to be a “true” or “flat” ellipse. Accordingly, an assumption can be made that such an ellipse can be represented in a two-dimensional (2D) coordinate system. FIG. 5 illustrates an example of a GPS ellipse used in determining a possible new AP location.

A standard ellipse has its major axis aligned with x-axis. A rotated ellipse can be represented using the orientation angle of this major axis with respect to the x-axis in a counterclockwise direction. The location data reported by an AP considers its “old_gps_info.orientation” as the angle at which its major axis is aligned with respect to the y-axis in a clockwise direction. Accordingly, this “old_gps_info.orientation” can be converted in a value, e, to be able to be used in standard ellipse mathematical operations. In this example,

$$θ = 90 - old\_gps \_info . orientation .$$

The center of the old/previous GPS ellipse 500 corresponds to a latitude/longitude value which is not in the Cartesian coordinate format. Thus, it is assumed that the center of this old/previous GPS ellipse is origin (0,0), and all other (x,y) values may be converted to the Cartesian coordinate system with respect to (old_gps_info.latitude, old_gps_info.longitude). This conversion to the Cartesioan coordinate system can be performed in accordance with the following algorithm:

# Calculate new gps lat/long w.r.t old gps lat/long
new_lat_cart, new_long_cart = convert_gps_to_pixel_coords([new_gps_info.latitude,
new_gps_info.longitude], [old_gps_info.latitude, old_gps_info.longitude])

where the parameter “coord” equals [new_gps_info.latitude, new_gps_info.longitude] and the parameter “ref” equals [old_gps_info.latitude, old_gps_info.longitude]. That is, the newly-reported GPS ellipse is overlapped with the previously-reported GPS ellipse. If the overlap exceeds a given threshold, the GPS location is considered to be unchanged.

The following ellipse inequality equation may be used to determine whether or not a point is inside, on, or outside of an ellipse, in this case, the old GPS ellipse. In order to use the following ellipse inequality equation, (x,y) coordinate values are converted to (x′,y′) coordinate values (because the ellipse 500 is rotated at an angle).

$$\frac{{x}^{′2}}{{y}^{2}} + \frac{{y}^{′2}}{{b}^{2}} \leq 1$$

The coordinates for an ellipse, such as ellipse 500, that is not parallel to the x-axis are converted as follows.

$${x}^{′} = x cos ( θ ) + y sin ( θ )$$

$${y}^{′} = - x sin ( θ ) + y cos ( θ )$$

The value of (x,y) is substituted with (new_lat_cart, new_long_cart) in the above equations to determine (x′,y′).

That is, the above equations become:

$${x}^{′} = new\_lat \_cart * cos ( orientation\_angle \_rad ) + new\_long \_cart * math . sin ( orientation\_angle \_rad )$$

$${y}^{′} = new\_long \_cart * cos ( orientation\_angle \_rad ) + new\_lat \_cart * math . sin ( orientation\_angle \_rad )$$

Having now calculated (x′,y′), the above ellipse inequality equation may be used to determine if a particular point or coordinate value is inside or on the old GPS ellipse 500, or if the point/coordinate value is outside the old GPS ellipse 500. If the (x′,y′) value per the ellipse inequality equation is less than or equal to one, the point is inside or on the old GPS ellipse 500. That is, the location of the AP has not changed significantly. If the (x′,y′) value per the ellipse inequality equation is greater than one, the point is outside of old GPS ellipse 500, indicating that the AP's location has changed significantly.

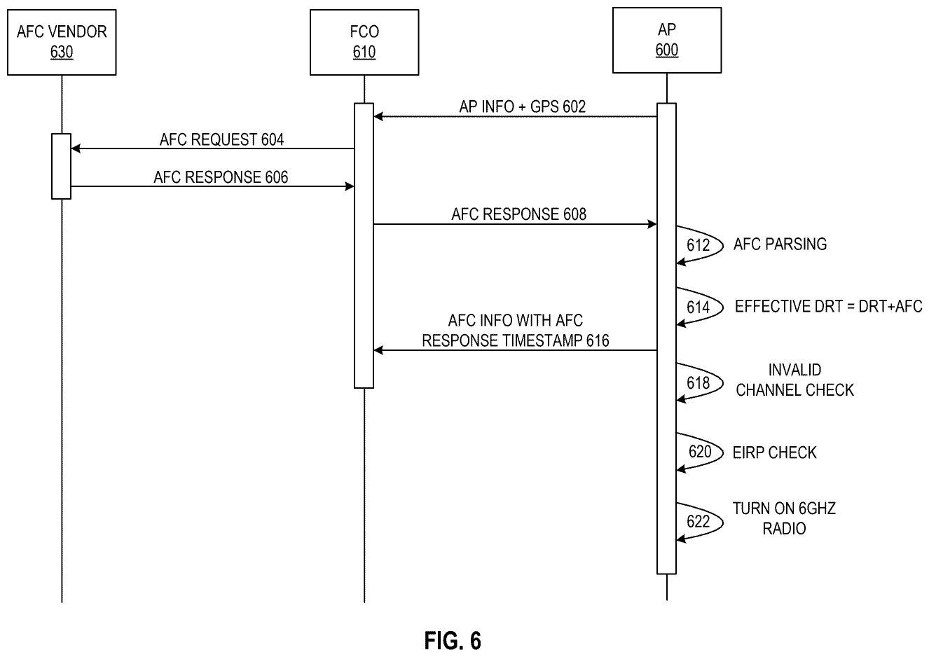

As discussed above, an FCO agent operating with a self-contained AP deployment's MCR may prioritize new APs by forwarding telemetry data (comprising AP state and location information) to the frequency coordination orchestrator upon detecting a new AP. FIG. 6 illustrates an example workflow for bringing up a new AP in accordance with examples of the disclosed technology.

As illustrated in FIG. 6, when an AP, such as AP 630 comes up/registers with the network, where that AP is configured with a 6 GHz radio, that 6 GHz radio is down or inoperative until the AP receives an AFC response indicating what (AFC) channel the AP may operate on, and at what power level. As described above, at 602, AP 630 may transmit its AP state/operating details along with its location information, e.g., GPS ellipse coordinates, to frequency coordination orchestrator 610. Frequency coordination orchestrator 610 may process the telemetry data (normalize, split if a silo'ed AP, compare new to old ellipse data, etc.) and ultimately, if warranted send an AFC request at 604, via an external GW (not shown in FIG. 6), to AFC vendor 630. AFC vendor 630 may respond at 606 with an AFC response indicating an allowed channel(s) or channel list as well as allowed power level(s), in particular Equivalent Isotropic Radiated Power (EIRP) limits for standard power operation on the 6 GHz bad. Frequency coordination orchestrator 610 can forward the AFC response at 608 to AP 600 via an MCR (to APs of a silo'ed deployment) or directly, via an AP telemetry pipeline in the case of an AP belonging to a cloud-managed deployment.

At 612, AP 600 can parse the AFC response received from frequency coordination orchestrator 610, and at 614, can determine the effective DRT. DRT refers to a downloadable regulatory table feature that allows new regulatory approvals to be distributed to APs without the need for a software upgrade or patch. The effective DRT refers to an updated DRT in which AFC data has been incorporated.

At 616, AP 600 may further transmit its state and location information to frequency coordination orchestrator 610 along with the timestamp corresponding to its receipt of the AFC response. AP 600 may then perform an invalid channel check at 618, and a EIRP check at 620, before turning on its 6 GHz radio at 622. The invalid channel and EIRP checks can be performed to determine if AP 600 is operating within the channel range and power level(s) defined in the effective DRT, allowing AP 600 to, e.g., filter out channels/power levels that are not allowed.

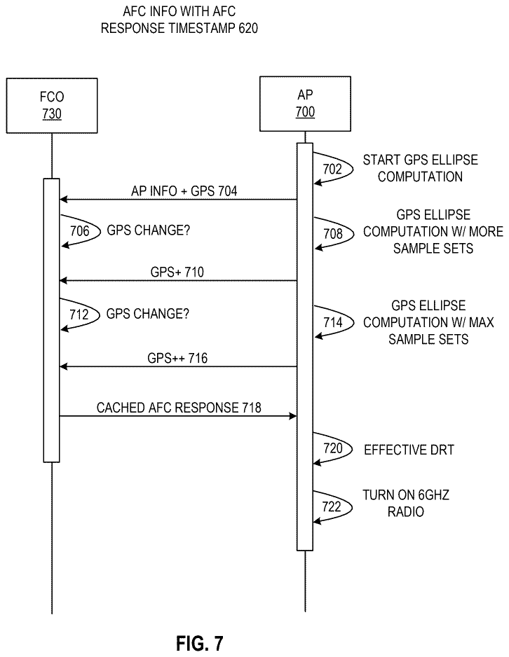

In addition to new APs, the FCO agent upon detecting a rebooting/restarting AP, will also prioritize transmitting that rebooting/restarting AP's telemetry data to the frequency coordinator orchestrator. FIG. 7 illustrates a rebooting/restarting AP workflow in accordance with examples of the disclosed technology, where AP 700 starts its new GPS ellipse calculations at 702 to determine if its location has changed significantly. Again, significant location changes can be determined based on whether or not the AP's new GPS ellipse coordinates are inside/on its old GPS ellipse coordinates. Accordingly, at 704, AP 700 may transmit its AP state and location information to frequency coordination orchestrator 730. Frequency coordination orchestrator 730 may determine (by comparing old/new GPS ellipse information) whether the location of AP 700 has changed. As noted above, AP 700 may perform its GPS ellipse computations using a larger sample set at 708 if frequency coordination orchestrator 730 cannot make a determination regarding location change. Thus, at 710, AP 700 transmits it GPS ellipse information to frequency coordination orchestrator 730 again. At 712, frequency coordination orchestrator 730 may attempt to determine whether or not AP 700's location has changed. If not, at 714, AP 700 may perform its GPS ellipse computations with a “maximum” sample set, with an understanding that the maximum sample set is considered to represent a new GPS location, negating the need for a subsequent GPS change determination. At 716, AP 700 once again may send its GPS ellipse information to frequency coordination orchestrator 730. Assuming, frequency coordination orchestrator 730 can now determine whether or not AP 700's location has changed, frequency coordination orchestrator 730 may send AP 700 a cached AFC response at 718. As described above with respect to FIG. 6, AP 700 may determine the effective DRT at 720, and at 722, may turn on it's 6 GHz radio for operation on the channel(s) and at the specified power level(s) specified in the cached AFC response AP 700 received from frequency coordination orchestrator 730. It should be understood that the use of larger and larger sample sets need not occur when frequency coordination orchestrator 730 is able to determine (using the aforementioned ellipse inequality equation) whether or not AP 700's location has changed.

As far as indoor AP deployments are concerned, or if an AP cannot establish its location, e.g., it cannot obtain a GPS fix, fine time measurements (FTM), a protocol used to determine distance between a Wi-Fi device and an AP, or pathloss can be used to derive location/GPS coordinates of the AP, based on some given “anchor” AP whose location may be known. Such derived location coordinates can also include an expanded uncertainty percentile value based on the FTM/pathloss measurement from the anchor AP.

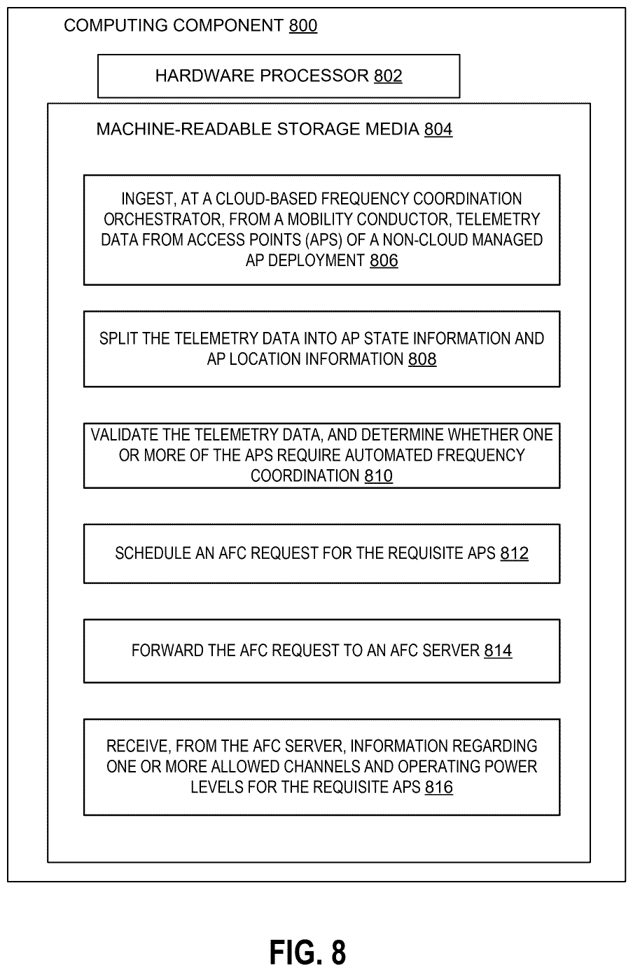

FIG. 8 illustrates a computing component that may be used to implement frequency coordination orchestration in accordance with various examples of the disclosed technology. Referring now to FIG. 8, computing component 800 may be, for example, a server computer, a controller, or any other similar computing component capable of processing data. In the example implementation of FIG. 8, the computing component 800 includes a hardware processor 802, and machine-readable storage medium 804.

Hardware processor 802 may be one or more central processing units (CPUs), semiconductor-based microprocessors, and/or other hardware devices suitable for retrieval and execution of instructions stored in machine-readable storage medium 804. Hardware processor 802 may fetch, decode, and execute instructions, such as instructions 806-816, to control processes or operations for frequency coordination orchestration. As an alternative or in addition to retrieving and executing instructions, hardware processor 802 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 804, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 804 may be a non-transitory storage medium, where the term “non-transitory” does not encompass transitory propagating signals. As described in detail below, machine-readable storage medium 804 may be encoded with executable instructions, for example, instructions 806-816

Hardware processor 802 may execute instruction 806 to ingest, at a cloud-based frequency coordination orchestrator, from a mobility conductor (MCR), telemetry data from APs of a non-cloud managed AP deployment. As discussed above, the frequency coordination orchestrator is able to ingest telemetry data from both cloud-based AP deployments as well as non-cloud-based AP deployments, self-contained or silo'ed deployments. In the case of cloud-based AP deployments, telemetry data can be ingested through a typical AP telemetry pipeline that can push the telemetry data to the frequency coordination orchestrator via a pubsub infrastructure. Thus, the frequency coordination orchestrator can support both silo'ed and non-silo'ed AP deployments.

Hardware processor 802 may execute instruction 808 to split the telemetry data into AP state information and AP location information. Because the frequency coordination orchestrator is configured to work with both silo'ed and non-silo'ed AP deployments, for uniformity and consistency, telemetry data from APs in a silo'ed deployment is split, commensurate with the manner in which telemetry data from APs belonging to non-silo'ed deployments is ingested, where AP and location information are kept separate.

Hardware processor 802 may execute instruction 810 to validate the telemetry data, and determine whether one or more of the APs require automated frequency coordination. As discussed above, a state processor validates incoming data (from the ingestion of AP telemetry), and filters out APs without valid information, and detects restarted/rebooted/new APs. That is sanity checks can be performed, e.g., checking the source of AP height and GPS information to see if those sources are allowed. If a sanity check fails regarding a particular AP, that AP can be ignored (for purposes of sending an AFC request). If the sanity check is passed, a scheduler can determine when an AFC request should be made for an AP identified by the state processor based on factors such as the AP's GPS position, time of day, expiry period of a previous AFC grant, and country code.

Hardware processor 802 may execute instruction 812 to schedule an AFC request for the requisite APs. If an AP is detected as being new, or undergoing/having undergone a reboot or restart, an AFC request may be warranted if an existing AFC response has expired. If the location of the AP has changed enough (i.e., if the AP's current GPS ellipse coordinates are outside its previous GPS ellipse coordinates), a new AFC request may be scheduled. The new AFC request will prompt the issuance of a new AFC response that specifies AFC channels and power levels according to which the APs may operate (without causing interference/collisions with incumbent communications or services). In other scenarios, such as when an AP has come up successfully, but has no AFC channel on which to operate, a cached AFC response, if valid, may be sent to the AP. Still other scenarios may warrant a new AFC request, such as to refresh AFC responses prior to their expiration, e.g., 24 hours.

Hardware processor 802 may execute instruction 814 to forward the AFC request to an AFC server (also referred to herein as an AFC vendor, i.e., an entity that is compliant with the FCC ULS). The AFC server or vendor operates to provide allowed AFC channels and power levels for an AP's particular location. As described above, a third party server or vendor is used because such entities must comply with the FCC ULS. Thus, hardware processor 802 may execute instruction 816 to receive, from the AFC server, information regarding one or more allowed channels and operating power levels for the requisite APs. For APs belonging to a silo'ed deployment, this information, i.e., an AFC response, can be forwarded to the MCR to be forwarded to the APs. For APs belonging to a non-silo'ed deployment this AFC response can be forwarded via the typical AP telemetry pipeline that exists in a cloud management platform that hosts the aforementioned frequency coordination orchestrator.

In accordance with examples of the disclosed technology, a centrally managed system that is able to support different customer use cases (cloud-managed versus non-cloud-managed deployments), is provided. Such a centrally managed system is able to scale and adapt to a customer's needs. Additionally in some examples, multiple AFC requests can be aggregated to prevent accidentally triggering a denial of service attack on the AFC vendor. Moreover, channel and power level assignments can be optimized in consideration of other applications, services, users.

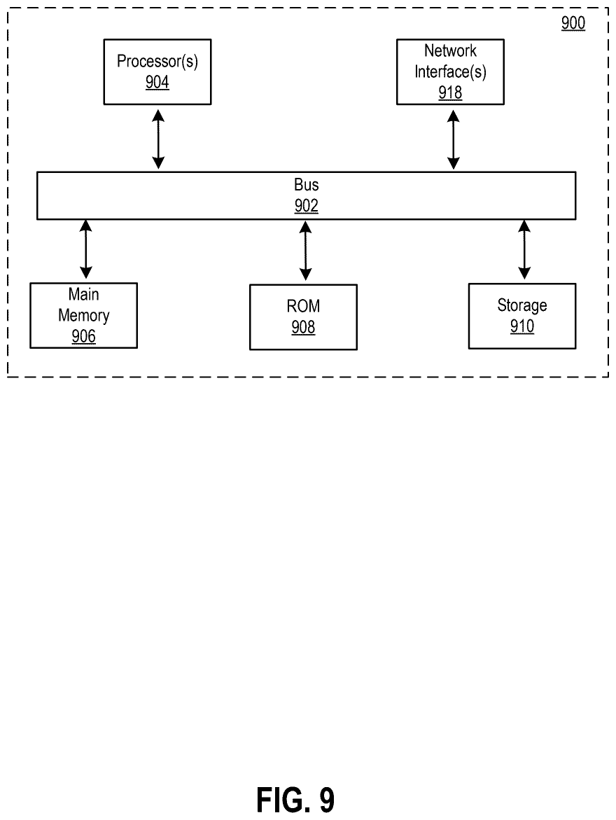

FIG. 9 depicts a block diagram of an example computer system 900 in which various examples of the disclosed technology described herein may be implemented. The computer system 900 includes a bus 902 or other communication mechanism for communicating information, one or more hardware processors 904 coupled with bus 902 for processing information. Hardware processor(s) 904 may be, for example, one or more general purpose microprocessors. Computer system 900 may be embodied as the disclosed frequency coordination orchestrator 204, or its components, an AP, a controller, etc.

The computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts.

The computer system 900 may implement the techniques described herein using customized hard-wired logic, one or more ASICs or FPGAs, firmware and/or program logic which in combination with the computer system causes or programs computer system 900 to be a special-purpose machine. According to one example of the disclosed technology, the techniques herein are performed by computer system 900 in response to processor(s) 904 executing one or more sequences of one or more instructions contained in main memory 906.

The term “non-transitory media,” and similar terms, as used herein refers to any media that store data and/or instructions that cause a machine to operate in a specific fashion. Such non-transitory media may comprise non-volatile media and/or volatile media. Non-transitory media is distinct from but may be used in conjunction with transmission media. Transmission media participates in transferring information between non-transitory media.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicated with a WAN). Wireless links may also be implemented. In any such implementation, network interface 918 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
ingesting, at a cloud-based frequency coordination orchestrator, from a mobility conductor (MCR), telemetry data from access points (APs) of a non-cloud AP managed deployment;
splitting the telemetry data into AP state information and AP location information;
validating the telemetry data, and determining whether one or more of the APs require automated frequency coordination (AFC);
scheduling an AFC request for the requisite APs;
forwarding the AFC request to an AFC server;
receiving, from the AFC server, information regarding one or more allowed channels and operating power levels for the requisite APs.

2. The method of claim 1, further comprising:
ingesting, at the cloud-based frequency coordination orchestrator, via an AP telemetry pipeline operatively connected to a pubsub event infrastructure, telemetry data from APs of a cloud managed AP deployment comprising cloud managed AP state information and cloud managed AP location information;
validating the telemetry data from the APs of the cloud managed AP deployment, and determining whether one or more of the APs of the cloud managed AP deployment require AFC;
scheduling an AFC request for the requisite APs of the cloud managed AP deployment;
forwarding the AFC request to an AFC server;
receiving, from the AFC server, information regarding one or more allowed channels and operating power levels for the requisite APs of the cloud managed AP deployment.

3. The method of claim 1, wherein a frequency coordination orchestrator agent residing in the MCR parses the AP state information and the AP location information from the telemetry data.

4. The method of claim 3, wherein the frequency coordination orchestrator agent forwards the AP state information and the AP location information to the cloud-based frequency coordination orchestrator via Representational State Transfer Application Programming Interfaces (REST APIs).

5. The method of claim 4, wherein the determination of whether the one or more APs require AFC comprises determining whether the one or more APs are new APs, APs that have been restarted, APs that have been rebooted, or APs operating in accordance with an AFC response that has or is to be expired.

6. The method of claim 5, wherein the frequency coordination orchestrator agent prioritizes the forwarding of the AP state information and the AP location information of those APS of the one or more APs that are new, have been started, or have been rebooted.

7. The method of claim 6, further comprising the frequency coordination orchestrator agent validating the information regarding the one or more allowed channels and operating power levels for the requisite APs, the information being received as an AFC response from the AFC server responding to the AFC request.

8. The method of claim 5, further comprising determining whether a location of the one or more APs having been rebooted has changed significantly enough to warrant the scheduling of the AFC request.

9. The method of claim 8, wherein the determination of whether the location of the one or more APs having been rebooted has changed significantly enough to warrant the scheduling of the AFC request is based on a comparison of current and previous Global Positioning System (GPS) coordinates representative of the location of the one or more APs.

10. The method of claim 9, wherein the comparison of the current and previous GPS coordinates is performed using a GPS ellipse-based comparison algorithm.

11. The method of claim 1, wherein the validation of the telemetry data comprises checking validity of AP height and GPS source information.

12. The method of claim 1, wherein the scheduling of the AFC request comprises calculating an AFC request schedule based on the AP deployment's timezone, an expiration time of a current AFC response, and an approximate time when channel and power assignment algorithms of the one or more APs will begin.

13. A cloud-based system, comprising:
a frequency coordination orchestrator ingesting telemetry data from access points (APs) of both a non-cloud managed AP deployment and a cloud managed AP deployment;
a scheduler component of the frequency coordination orchestrator:
determining whether one or more of the APs require automated frequency coordination (AFC); and
scheduling an AFC request for those APs requiring AFC;
a gateway of the frequency coordination orchestrator:
forwarding the AFC request to an AFC server; and
receiving, from the AFC server, and AFC response comprising one or more allowed channels and operating power levels for the APs requiring AFC.

14. The cloud-based system of claim 13, further comprising splitting the telemetry data associated with the one or more APs of the non-cloud managed AP deployment to comport with a manner in which AP state information and AP location information associated with the one or more APs of the cloud managed AP deployment are received.

15. The cloud-based system of claim 13, wherein the determination of whether the one or more APs require AFC comprises determining whether the one or more APs are new APs, APs that have been restarted, APs that have been rebooted, or APs operating in accordance with an AFC response that has or is to be expired.

16. The cloud-based system of claim 15, wherein a frequency coordination orchestrator agent operating in a mobility controller associated with the non-cloud managed AP deployment prioritizes the forwarding of the AP state information and the AP location information of those APS of the one or more APs that are new, have been started, or have been rebooted.

17. The cloud-based system of claim 16, wherein the frequency coordination orchestrator agent receives the AFC response, the AFC response having been forwarded by the gateway of the frequency coordination orchestrator.

18. The cloud-based system of claim 17, wherein the frequency coordination orchestrator agent validates the AFC response prior to forwarding to the one or APs requiring AFC.

19. A system comprising:
a processor; and
a memory comprising instructions that when executed, cause the processor to:
receive telemetry data from access points (APs) of a non-cloud AP managed deployment and a cloud managed AP deployment;
process the telemetry data by separating the telemetry data into AP state information and AP location information;
determining whether one or more of the APs require automated frequency coordination (AFC) based on the one or more APs being new APs, APs that have been restarted, APs that have been rebooted, or APs that are operating in accordance with expired AFC channel and operating power level information;
scheduling an AFC request for the requisite APs;
forwarding the AFC request to an AFC server;
receiving, from the AFC server, information regarding one or more allowed channels and operating power levels for the requisite APs.

20. The system of claim 19, wherein the expiration of the AFC channel and operating power level information is associated with at least one of an expired AFC response time period and a location change associated with the one or more APs.
